(19) United States
(12) Patent Application Publication
(10) Pub. No.: US 2018/0370280 A1
(43) Pub. Date: Dec. 27, 2018

(54) SYSTEM AND METHOD FOR PREDICTING FAILURE OF A WHEEL BEARING IN VEHICLE

(71) Applicant: GM GLOBAL TECHNOLOGY OPERATIONS LLC, Detroit, MI (US)

(72) Inventors: HESAM AKBARIAN, OSHAWA (CA); RICK SZYMCZYK, WHITBY (CA); GRANT L. MEADE, WHITBY (CA)

(73) Assignee: GM GLOBAL TECHNOLOGY OPERATIONS LLC, Detroit, MI (US)

(21) Appl. No.: 15/632,624

(22) Filed: Jun. 26, 2017

(51) Int. Cl. B60B 27/00; G01K 13/00

(52) U.S. Cl. CPC B60B 27/0068; G01K 13/00

(57) ABSTRACT

Methods and apparatus are provided for predicting potential failure of wheel bearings in a vehicle. The apparatus includes a temperature sensor configured to measure a temperature value for a wheel bearing and a processor for comparing the temperature value to a threshold value. When the temperature value exceeds the threshold value, the process provides an indication to warn of the potential failure of the wheel bearing. The method includes operating the vehicle for a time period and measuring a temperature value for the wheel bearing after the time period. Next, the temperature value is compared to a threshold value for the wheel bearing. When the wheel bearing temperature value exceeds the threshold value, and indication is provided to warn of the potential failure of the wheel bearing.

### INTRODUCTION

The present disclosure generally relates to vehicle wheel bearings, and more particularly relates to a system and method for predicting failure of wheel bearing.

Road vehicles typically employ wheel bearings in the wheel and axle assemblies. Despite extensive grinding and polishing, no ball bearing is perfectly spherical nor are the inner cage or outer cage of the bearing perfectly smooth. As a result, bearings may produce vibrations and noise as the wheel bearings age and wear. Accordingly, one technique for monitoring the performance of wheel bearings is to measure vibration and noise during service intervals of the vehicle. However, to do this the vehicle must be taken out of service while the bearings are being inspected, and may require a technician to remove or disassemble the wheel bearing.

Accordingly, it is desirable to provide a non-intrusive method of measuring wheel bearing performance and predicting wheel bearing failure. In addition, it is desirable to be able to make these measurements and predictions while the vehicle is in service and operating on the roadways. Furthermore, other desirable features and characteristics of the present invention will become apparent from the subsequent detailed description of the invention and the appended claims, taken in conjunction with the accompanying drawings and the background of the invention.

### SUMMARY

An apparatus is provided for predicting potential failure of wheel bearings in a vehicle. The apparatus includes an accurate temperature sensor configured to measure temperature of a wheel bearing and a processor for comparing the temperature value to a threshold value. When the temperature value exceeds the threshold value, the process provides an indication to warn of the potential failure of the wheel bearing.

In other aspect of the disclosure, the apparatus includes a memory having a plurality of threshold values respectively associated with this vehicle speed value and a vehicle speed sensor for determining the vehicle speed value.

In other aspect of the disclosure, the apparatus includes a signal processor for receiving the temperature value in providing a process to temperature value for comparison.

In other aspect of the disclosure, the vehicle is a passenger vehicle and the processor is configured to compare the temperature value to the threshold value after the passenger vehicle has been driven for a time period.

In other aspect of the disclosure, the processor is configured to store the temperature value they date value and to periodically re-compare the temperature value to the threshold value based upon the date.

A method is provided for predicting potential failure of a wheel bearing in a vehicle. The method includes operating the vehicle for a time period and measuring a temperature value for the wheel bearing after the time period. Next, the temperature value is compared to a threshold value for the wheel bearing. The method provides an indication is provided to warn of the potential failure of the wheel bearing when the wheel bearing temperature value exceeds the threshold value.

In another aspect of the disclosure, the method includes processing the temperature value to provide a processed value and then comparing the processed temperature value to the threshold value.

In another aspect of the disclosure, conditioning the temperature signal includes level shifting and buffering the temperature signal make it ready for process in signal processing unit.

In another aspect of the disclosure, the method includes determining a speed of the vehicle and selecting the threshold value based upon the speed of the vehicle.

In another aspect of the disclosure, the vehicle is a passenger vehicle and the method includes operating passenger vehicle for the time period.

Another aspect of the disclosure, the vehicle is a trailer and the method includes towing the trailer for the time period.

In another aspect the disclosure, the method includes storing the temperature value in a memory with a date that temperature value is measured.

In other aspect of the disclosure, the method is periodically repeated based upon the stored date.

In another aspect of the disclosure, the method includes measuring the temperature values of a first and second wheel bearing to provide first and second temperature values respectively. The first and second temperature values are subtracted and the difference value compared to the threshold value. When the difference value exceeds the threshold value the first and second temperature values are compared to determine whether the first or second bearing has failed. When the temperature difference does not exceed the threshold value each of the first and second temperature values are compared to the threshold value to determine whether one or both of the first and second bearings has failed.

### BRIEF DESCRIPTION OF THE DRAWINGS

The present disclosure will hereinafter be described in conjunction with the following drawing figures, wherein like numerals denote like elements, and

FIG. 1 is an illustration of a semi tractor-trailer in accordance with an embodiment;

FIGS. 2A-C are illustrations of a passenger vehicle and trailers that may be towed by the passenger vehicle in accordance with an embodiment;

FIGS. 3A-C our further illustrations of a passenger vehicle and trailers that may be towed by the passenger vehicle in accordance with an embodiment; and

FIG. 4 is a chart illustrating the correlation between vehicle speed and wheel bearing temperature in accordance with embodiment;

FIG. 5 is an illustration of a correlated vehicle speed and wheel bearing aperture threshold in accordance that embodiment;

FIG. 6 is a block diagram illustrating the wheel bearing measurement system in accordance with an embodiment;

FIG. 7 is a flow diagram illustrating a method in accordance with an embodiment;

FIGS. 8A-B are flow diagrams illustrating another method in accordance with an embodiment;

FIG. 9 is a chart illustrating a correlation between of vehicle speed and wheel bearing temperature as an R-C rise and decay time constant in accordance with embodiment;

FIG. 10 is a schematic diagram illustrating an equivalent circuit in accordance with embodiment;

FIG. 11 is an equation modeling the schematic diagram of FIG. 10 for providing temperature threshold values as a function of vehicle speed in accordance with embodiment.

### DETAILED DESCRIPTION

The following detailed description is merely exemplary in nature and is not intended to limit the disclosure or the application and uses of the system and method disclosed herein. Furthermore, there is no intention to be bound by any theory presented in the preceding background or the following detailed description.

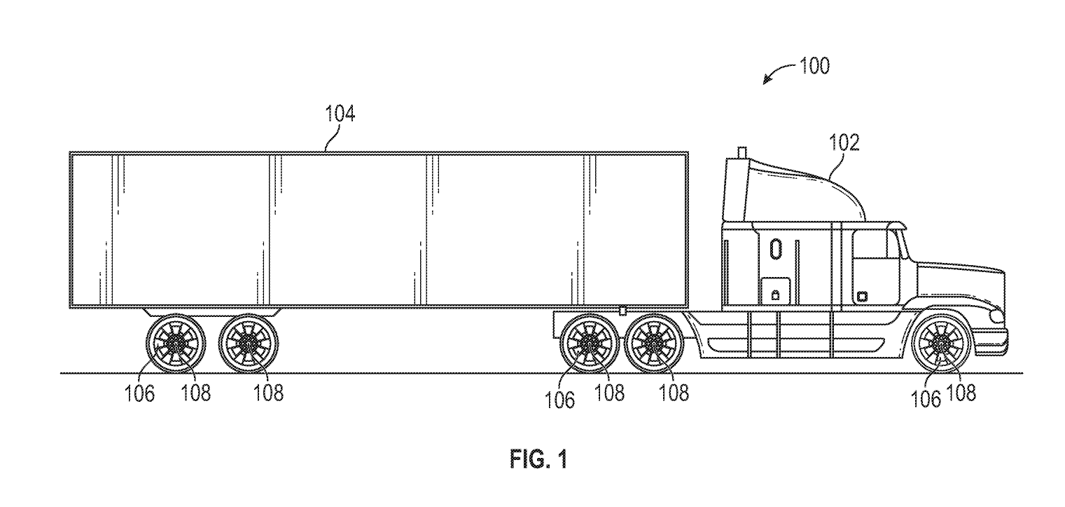

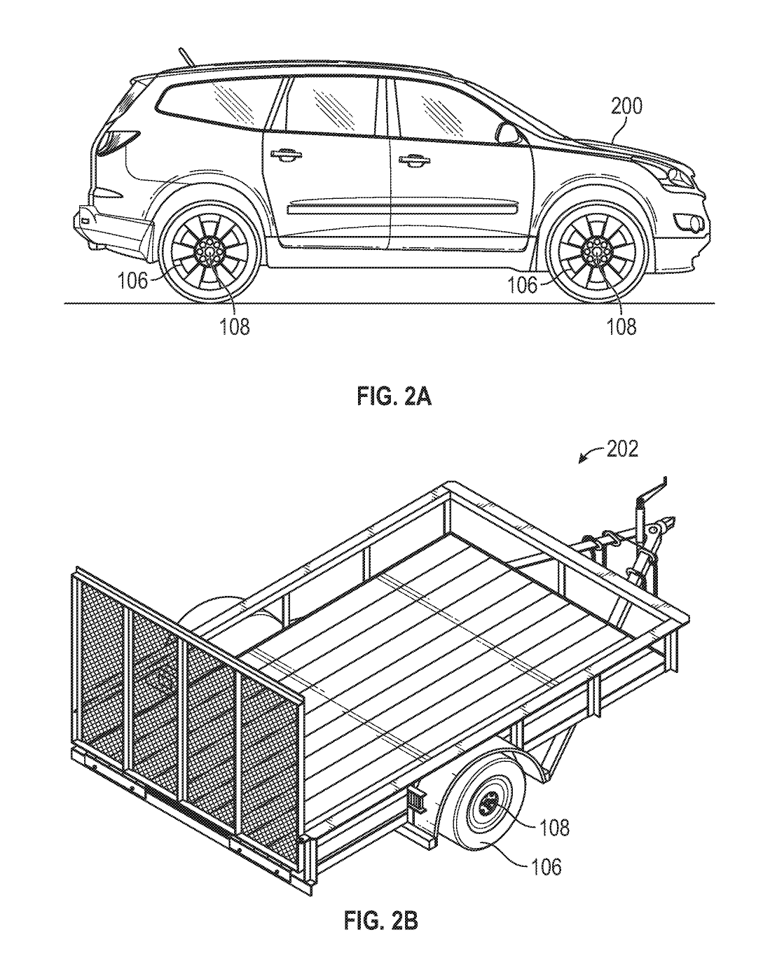

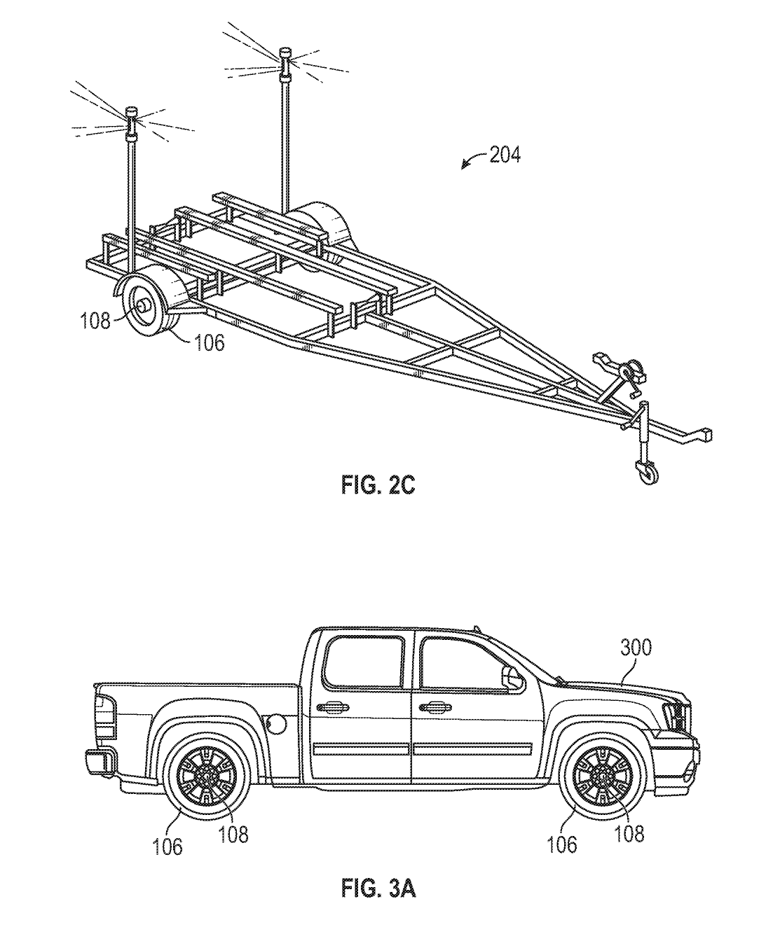

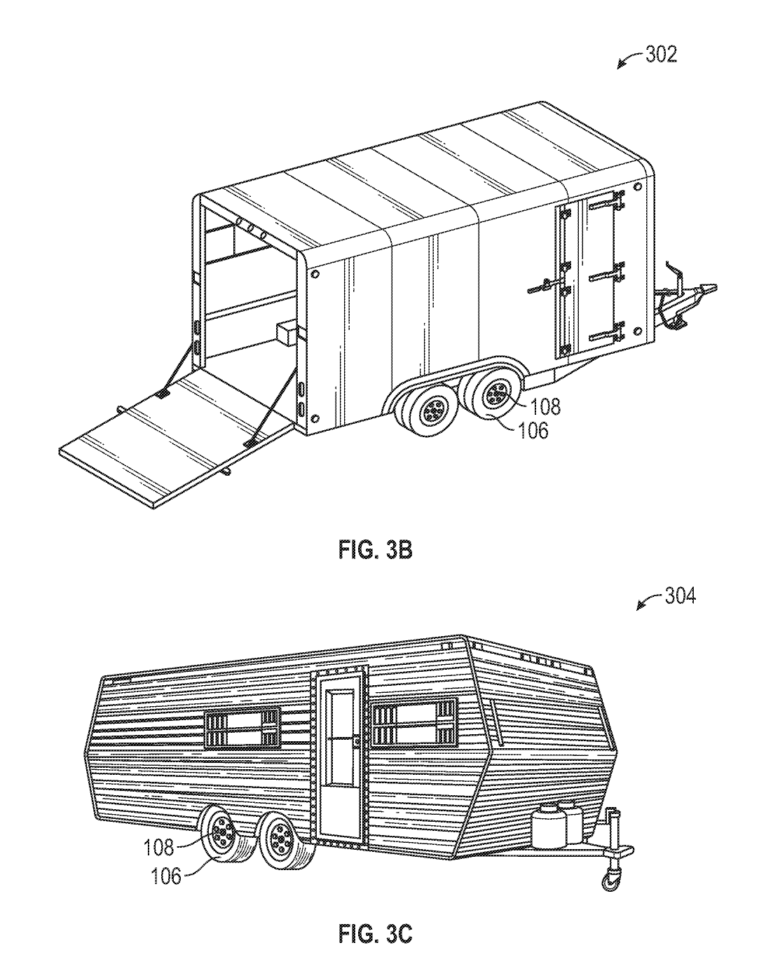

FIG. 1 is an illustration of a semi tractor-trailer 100 suitable for incorporating the teachings of the present disclosure in accordance with exemplary embodiments. The semi tractor-trailer 100 includes a tractor 102 for towing a trailer 104 for the transportation a variety of goods along the roadways. Both the tractor 102 and the trailer 104 employ tire and wheel assemblies 106 each of which has a wheel bearing 108. As used herein, the term “vehicle” includes passenger vehicles and trailer vehicles that may be towed by passenger vehicles along the roadways. All types of vehicles are contemplated by the present disclosure, non-limiting examples of which include the passenger vehicle 200 illustrated in FIG. 2A, which may toe a utility trailer 202 (FIG. 2B) or a boat trailer 204 (FIG. 2C) or other trailer having a weight within the passenger vehicle 200 towing capability. Other non-limiting examples includes a truck passenger vehicle 300 illustrated in FIG. 3A, which may toe a contractors trailer 302 (FIG. 3B) or recreational vehicle trailer 304 (FIG. 3C).

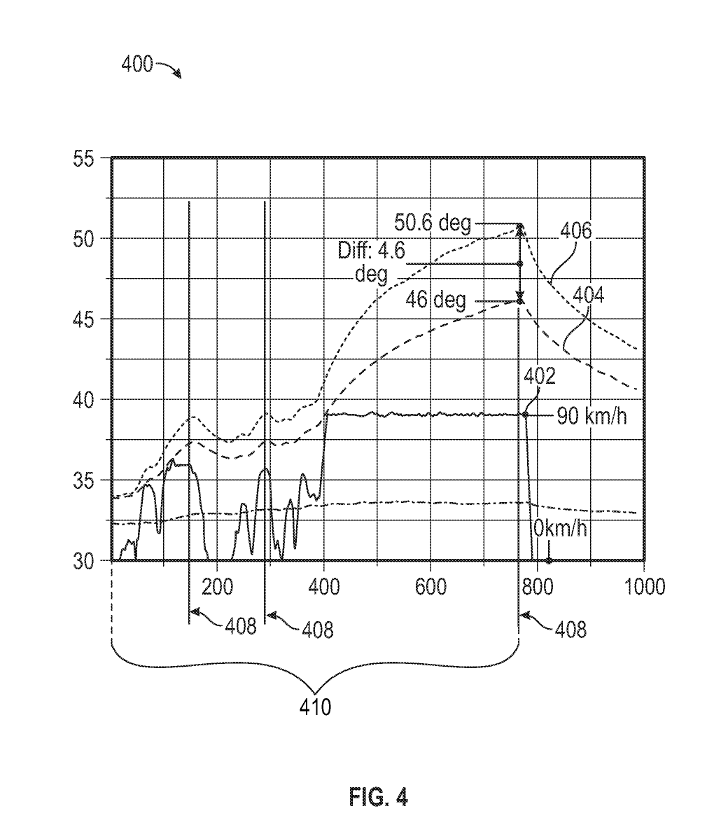

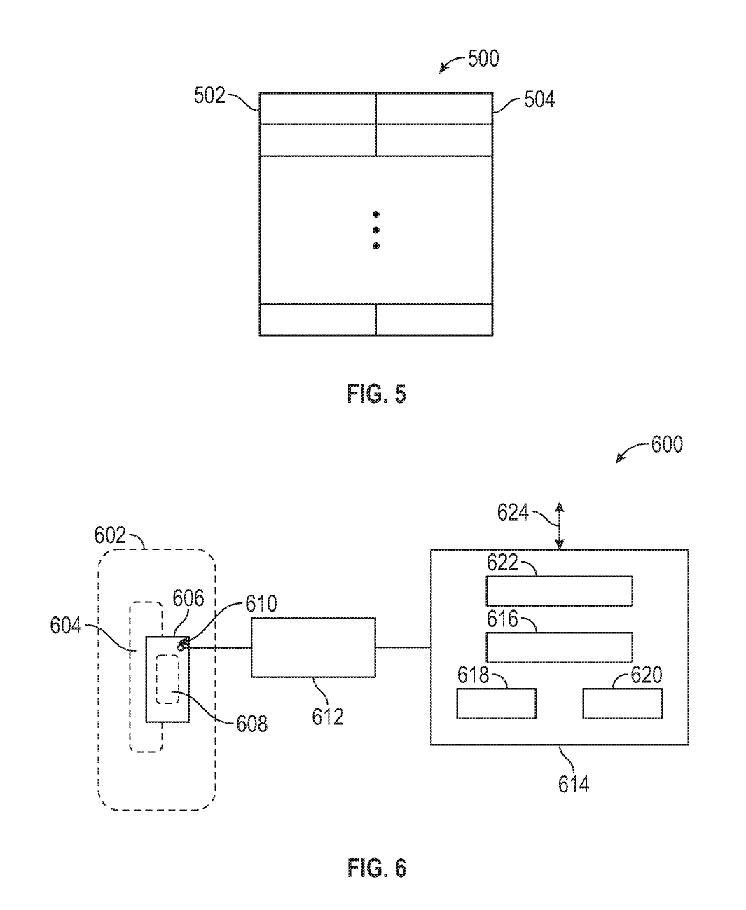

FIG. 4 is a chart 400 illustrating the relationship between vehicle speed 402 and the measured temperature of a good (within specification tolerance) wheel bearing 404 and a potentially failing wheel bearing 406. As can be seen, vehicle speed can be correlated with the rise and fall in temperature as illustrated that correlation points 408. This correlation between speed and wheel bearing temperature is quite pronounced particularly after the vehicle has been operated for a time period 410 so that the wheel bearings have heated beyond an initial or ambient temperature to an operational temperature. In fundamental embodiments of the present disclosure, the systems and methods disclosed herein utilize the principal that a potential mechanical malfunction a wheel bearing, or a wheel bearing operating out of specification tolerances, will have increased heat due to the increase in rotational torque of the wheel bearing. Using this information, a correlation between vehicle speed and a temperature threshold for a wheel bearing within operational tolerances can be created empirically or using manufacturer specification data. As a non-limiting example, the temperature threshold may be set to 5-10% (Celsius) above the manufacture's specification for bearing temperature at a given speed. In such an embodiment, a temperature gap between a failed bearing and a bearing within specification would be approximately 2-3° C. These values can be stored in a table 500 as illustrated in FIG. 5 with a respective speed value 502 correlating to an expected temperature threshold 504.

FIG. 6 is a block diagram illustrating a non-limiting embodiment of the present disclosure. A vehicle tire 602 is mounted onto a wheel 604 which in turn is mounted to an axle assembly 606 which contains a wheel bearing 608. A temperature sensor 610 is positioned in proximity to the wheel bearing in order to take a measurement of wheel bearing temperature. In some embodiments, the temperature sensor 610 comprises a negative temperature coefficient (NTC) thermistor which has a varying resistance in response to changes in temperature. In some embodiments, the NTC thermistor utilized may be a high-accuracy (e.g., error less than 5%) device. The temperature value measured by the temperature sensor 610 sent to a signal conditioning block 612. In some embodiments, the signal conditioning block 612 provides a level shifting function to bring the value of the temperature sensor to a level that can be detected by the microcontroller in the signal processing unit (Microcontroller) 614. In other embodiments, other signal processing techniques such as filtering or analog-to-digital conversion may be employed in any particular embodiment as needed. The microcontroller 614 receives the conditioned signal from the signal conditioning block 612 and uses a processor 616 to compare the temperature value to a temperature threshold stored in a memory 618. In some embodiments, the memory 618 stores a vehicle speed to temperature threshold listing as discussed above in connection with FIG. 5. If the temperature value does not exceed the temperature threshold, the measured temperature reading can be stored in memory 618 along with a time and date stamp provided by the clock 620, which can be interrogated by a technician at the next regularly scheduled service of the vehicle for further analysis of the performance of the wheel bearings. Conversely, if the wheel bearing temperature exceeds the temperature threshold than the processor can provide an indication of potential wheel bearing failure by that communication block 622 over a communications bus 624. In some embodiments, the communication bus 624 may be an Onboard Diagnostics (OBD) bus or a Controller Area Network (CAN) bus.

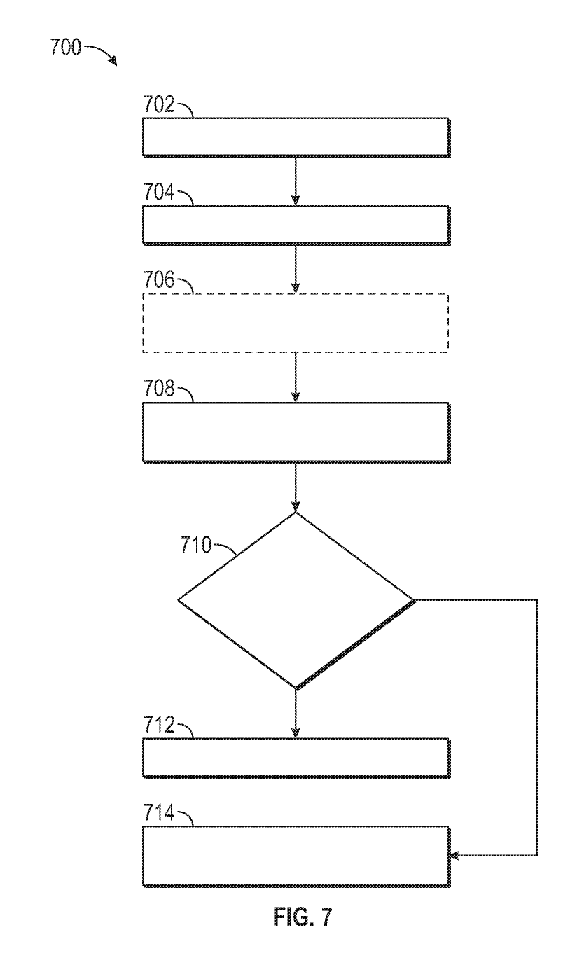

FIG. 7 is a flow diagram illustrating a method 700 in accordance with an embodiment of the present disclosure. In block 702, the vehicle is operated for a time period (e.g., one hour) to bring the wheel bearings up to an operational temperature. In block 704 a temperature measurement is taken of the wheel bearing using the system discussed above in connection with FIG. 6. Optionally, the vehicle speed may be measured in a corresponding temperature threshold selected in block 706 as discussed above in connection with FIG. 5. Next, block 708 compares the temperature value to the (selected) temperature threshold in block 710 determines whether the temperature value exceeds the temperature threshold. If so, then an indication is provided in block 712 to call to the vehicle operator's attention the potential failure of the wheel bearing. Conversely, if the wheel bearing temperature value does not exceed the temperature threshold block 714 stores the bearing temperature and date of the temperature measurement, which may be used to periodically repeat the process on any desired schedule (e.g., daily, weekly, monthly). Additionally, as mentioned above, the stored bearing temperature and dates can be used by a technician during a regular scheduled maintenance of the vehicle to gauge the progression of wheel bearing heating over the course of time recorded by the system of FIG. 6.

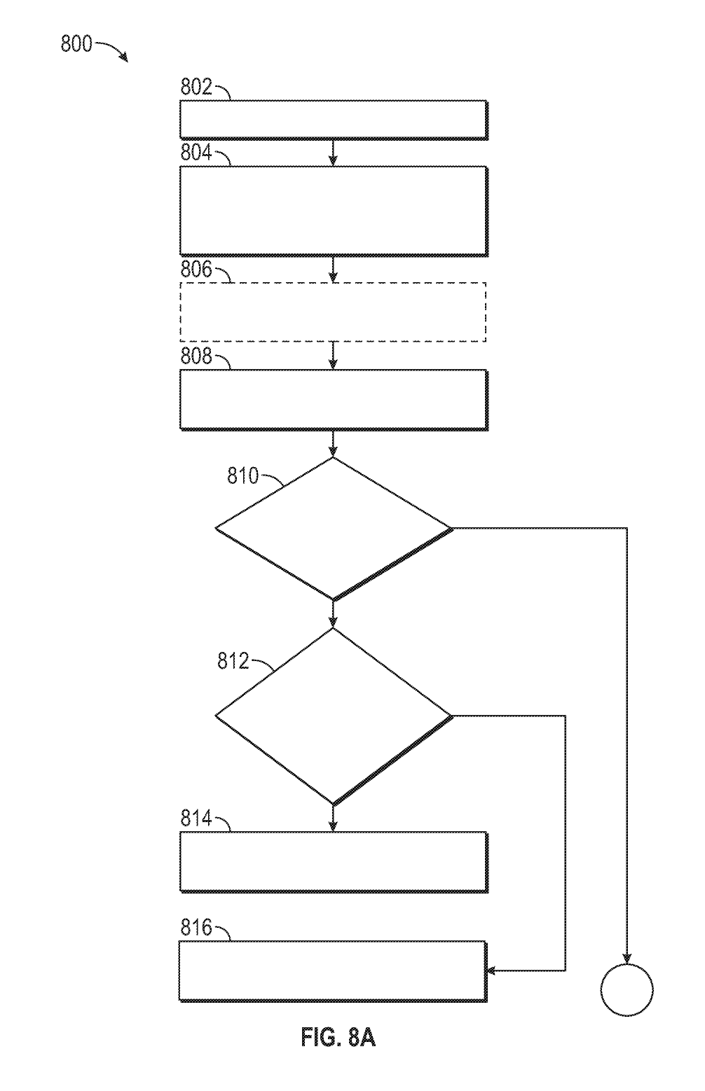

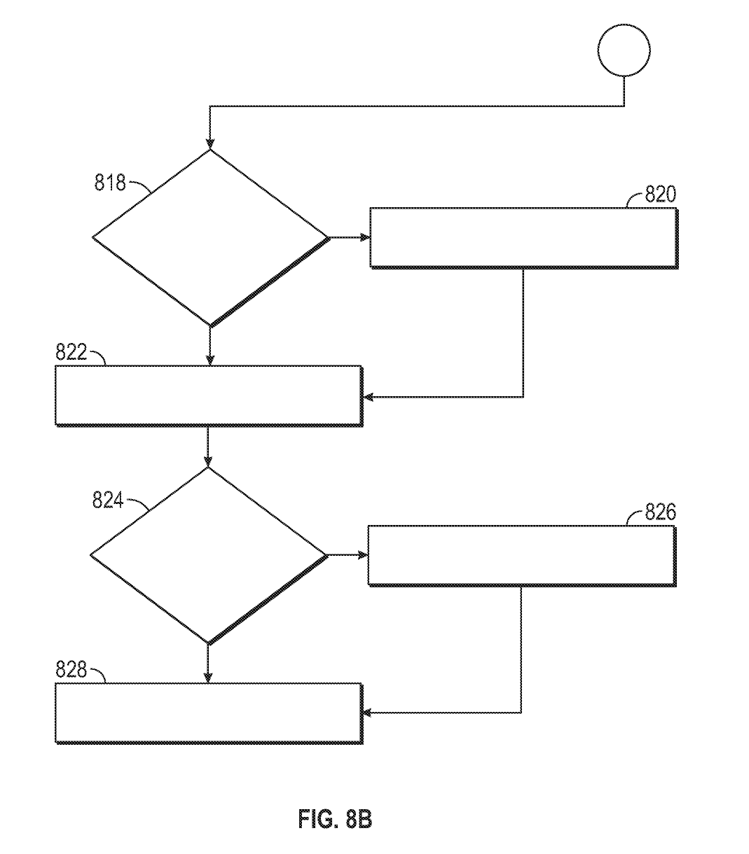

FIGS. 8A-C is a flow diagram of another method 800 of the present disclosure in accordance with an embodiment. In the process of method 800, an advantage is offered in that to wheel bearings may be examined simultaneously by the process 800. The process begins with the vehicle is operated for a time period in block 802. Next, measurements are taken in block 804 away first wheel bearing temperature (T_{B1}) and a second wheel bearing temperature (T_{B2}). Optionally, the vehicle speed can be measured and a bearing temperature threshold selected in block 806 as discussed above in connection with FIG. 5. In block 808, the temperature value of the first wheel bearing in the temperature value of the second will bearing are subtracted and the difference value from that subtraction is compared to the threshold. If the difference temperature exceeds the threshold, then a substantial temperature gap exists between the first wheel bearing in the second will bearing indicating that one of them has failed or has the potential to fail. Accordingly, block 812 determines whether they first bearing temperature exceeds the second bearing temperature if so then that indication is given indicating the potential failure of the first bearing. Conversely, if the first bearing temperature does not exceed the second bearing temperature that indication is given that the second bearing will potentially fail.

Returning to block 810, a determination that the difference in temperature between the first wheel bearing and the second wheel bearing does not exceed the threshold, may be the result of both bearings having failed. Accordingly, block 818 determines whether the temperature of the first bearing exceeds the temperature threshold. If so, and indication is provided that the first wheel bearing may potentially fail in block 820. The first bearing temperature and date are stored (block 822) and the method continues. Conversely, if the temperature value of the first wheel bearing does not exceed the temperature threshold the temperature value and the date is stored in block 822. Next block 824 determines whether the temperature value of the second wheel bearing exceeds the threshold. If so, block 826 provides an indication the operator of the vehicle that the second wheel bearing may potentially fail and the second bearing temperature and date are stored (block 828). A negative termination of block 824 results in the temperature value for the second wheel bearing being stored along with the date of the temperature measurement in block 828.

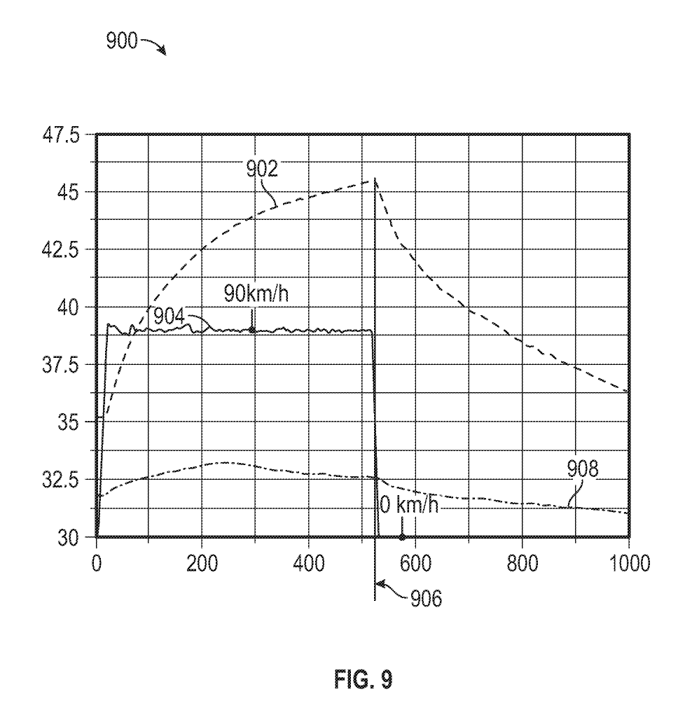

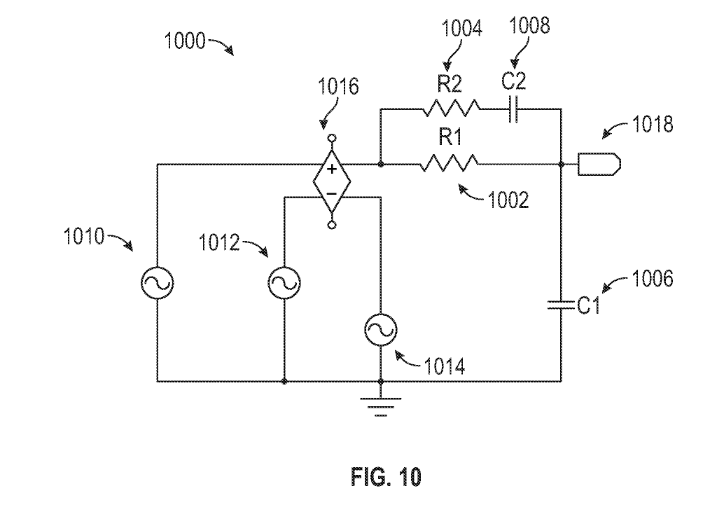

FIGS. 9-11 illustrate a non-limiting embodiment for predicting the bearing threshold temperature for use in the methods of FIG. 7 and FIGS. 8A-8B. As will be appreciated, those of ordinary skill in the art may empirically or with manufacturer's data create the temperature threshold table of FIG. 5. However, note that in FIG. 4 it can be see that when the vehicle is operated at approximately a constant speed for a time period and then stops, that the bearing temperature curve resembles the charge-discharge curve of an R-C electric circuit. This is illustrated in FIG. 9, where the chart 900 illustrates bearing temperature 902 rising exponentially while the vehicle is being operated at a substantially constant speed 904. Then when the vehicle speed goes to zero at 906, the bearing temperature curve 902 decays as in an R-C electric circuit. Additionally, modest variations in bearing temperature can be seen to be related to the ambient temperature 908. Building on this observation, and employing circuit modeling techniques, an equivalent circuit is presented in the circuit diagram of FIG. 10.

In FIG. 10, the R-C portion of the circuit is derived from bearing specifications depending upon the particular bearing employed in any particular embodiment. Thus, the equivalent values for resistor R1 (1002), R2 (1004), C1 (1006) and C2 (1008) will be generated from the bearing manufacturer's data. Voltage sources representing the vehicle speed (1010), vehicle weight (1012) and ambient temperature (1014) are combined in combiner 1016 and applied to the R-C circuit to provide a predicted bearing threshold temperature 1018 as a function of vehicle speed, weight and ambient temperature.

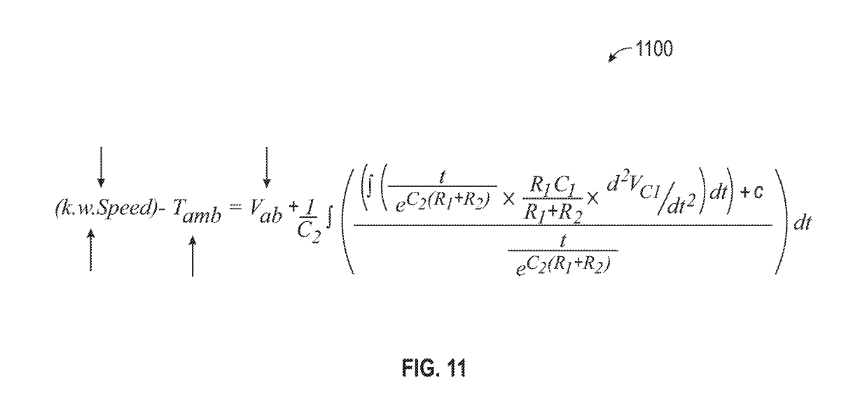

FIG. 11 presents an equation 1100 representing the equivalent circuit of FIG. 10 where: k is a constant derived from axle mass and bearing size, w is the vehicle weight, Speed is the vehicle speed and T_{amb} is the ambient temperature. Multiplying k, w and Speed and subtracting T_{amb} yields V_{ab}, which is the bearing initial condition which is added to the integration of the R-C values of FIG. 10 as shown in equation 1100. This value then can be applied as the bearing threshold in the methods of FIG. 7 and FIGS. 8A-8B as discussed above.

The exemplary system and method disclosed herein provide a non-invasive early warning of potential bearing failures can provide a benefit to vehicle operators by being able to schedule service at a convenient time as opposed to after complete bearing failure. Moreover, continuous and periodic measurement of the performance of the wheel bearings may be obtained while the vehicle is in service and operating on the roadways.

While at least one exemplary aspect has been presented in the foregoing detailed description of the disclosure, it should be appreciated that a vast number of variations exist. It should also be appreciated that the exemplary aspect or exemplary aspects are only examples, and are not intended to limit the scope, applicability, or configuration of the disclosure in any way. Rather, the foregoing detailed description will provide those skilled in the art with a convenient road map for implementing an exemplary aspect of the disclosure. It being understood that various changes may be made in the function and arrangement of elements described in an exemplary aspect without departing from the scope of the disclosure as set forth in the appended claims.

What is claimed is:

1. A method for predicting potential failure of a wheel bearing in a vehicle, comprising:
operating the vehicle for a time period;
measuring a temperature value for the wheel bearing after the time period;
comparing the temperature value to a threshold value for the wheel bearing; and
providing an indication of potential failure of the wheel bearing when the temperature value exceed the threshold value.

2. The method of claim 1, further comprising:
conditioning the temperature value to provide a conditioned temperature value; and
comparing the processed temperature value to the threshold value.

3. The method of claim 2, where conditioning the temperature value comprise level shifting the temperature value to provide the conditioned temperature value.

4. The method of claim 1, further comprising:
determining a speed of the vehicle; and
selecting the threshold value based upon the speed of the vehicle.

5. The method of claim 1, wherein the vehicle is a passenger vehicle and the step of operating comprises operating the passenger vehicle for the time period.

6. The method of claim 1, wherein the vehicle is a trailer and the step of operating comprises towing the trailer for the time period.

7. The method of claim 1, further comprising;
storing the temperature value in a memory with a date that the temperature value was measured; and
periodically repeating the method of claim 1 based upon the date.

8. A method for predicting potential failure of wheel bearings in a vehicle, comprising:
operating the vehicle for a time period;
measuring a first temperature value for a first wheel bearing after the time period;
measuring a second temperature value for a second wheel bearing after the time period;
subtracting the first temperature value from the second temperature value to provide a difference value;
comparing the difference value to a threshold value;
when the difference value exceeds the threshold value, comparing the first temperature value and second temperature to determine which of the first and second wheel bearing has a potential to fail and providing an indication of potential failure of the first or second wheel bearing; and
when the difference value does not exceed the threshold value, comparing the first temperature value to the threshold value to determine whether the first wheel bearing has a potential to fail and comparing the second temperature value to the threshold value to determine whether the second wheel bearing has a potential to fail and providing an indication of potential failure of the first or second wheel bearing when a respective temperature value exceeds the threshold value.

9. The method of claim 8, further comprising:
conditioning the first temperature value to provide a first conditioned temperature value; and
conditioning the second temperature value to provide a second conditioned temperature value.

10. The method of claim 9, where conditioning the first and second temperature value comprise level shifting the first and second temperature value to provide the first and second conditioned temperature value.

11. The method of claim 8, further comprising:
determining a speed of the vehicle; and
selecting the threshold value based upon the speed of the vehicle.

12. The method of claim 8, wherein the vehicle is a passenger vehicle and the step of operating comprises operating the passenger vehicle for the time period.

13. The method of claim 8, wherein the vehicle is a trailer and the step of operating comprises towing the trailer for the time period.

14. The method of claim 8, further comprising;
storing the first and second temperature values in a memory with a date that the first and second temperature values were measured; and
periodically repeating the method of claim 8 based upon the date.

15. A vehicle having a system for predicting potential failure of wheel bearings, comprising:
a temperature sensor configured to measure a temperature value for a wheel bearing; and
a processor for comparing the temperature value to a threshold value and for providing an indication of potential failure of the wheel bearing when the temperature value exceed the threshold value.

16. The vehicle of claim 15, further comprising:
a memory having a plurality of threshold values respectively associated with a vehicle speed value;
a vehicle speed sensor for providing the vehicle speed value; and
wherein the threshold value is selected by the processor based upon the vehicle speed value.

17. The vehicle of claim 15, further comprising a signal processor for receiving the temperature value and provided a processed temperature value.

18. The vehicle of claim 15, wherein the vehicle is a trailer and the processor is configured to compare the comparing the temperature value to the threshold value after the trailer has been towed for a time period.

19. The vehicle of claim 15, wherein the vehicle is a passenger vehicle and the processor is configured to compare the comparing the temperature value to the threshold value after the passenger vehicle has been driven for a time period.

20. The vehicle of claim 15, wherein the processor is configured to store the temperature value with a date value and to periodically re-compare the temperature value to the threshold value based upon the date value.
